(19) United States
(12) Patent Application Publication
(10) Pub. No.: US 2025/0305906 A1
(43) Pub. Date: Oct. 2, 2025

(54) POSITIONING DEVICE AND POSITIONING METHOD

(71) Applicant: NIPPON TELEGRAPH AND TELEPHONE CORPORATION, Tokyo (JP)

(72) Inventors: Daiki KOBAYASHI, Tokyo (JP); Toshiki NAKANISHI, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/863,740

(22) PCT Filed: May 9, 2022
(86) PCT No.: PCT/JP2022/019709

§ 371 Date: Nov. 7, 2024

(51) Int. Cl. G01M 7/04; G01M 7/02

(52) U.S. Cl. CPC G01M 7/04; G01M 7/025

(57) ABSTRACT

An alignment device (3) according to the present disclosure includes a laser emitter (31) that emits laser light (L) and is provided such that the laser light (L) reaches a position on a straight line extending in a vibrating direction from a tip of a stinger (12), the position being on the vibrating direction side from the tip, a laser receiver (32) that is provided to receive the laser light (L) reflected by an object (A) when the vibrator body (1) is installed such that the vibrating direction is a normal direction at a vibrating position on a surface of the object (A), and a controller (33) that determines whether an amount of the laser light (L) is a predetermined value or greater.

### TECHNICAL FIELD

The present invention relates to an alignment device and an alignment method.

### BACKGROUND ART

In constructing a structure, it is known to measure a natural frequency or the like of the structure by a modal testing for the purpose of preventing resonance from occurring in the structure (see Non Patent Literature 1). The modal testing according to the simplest and most general method is performed using an impulse hammer and an accelerometer.

Since the impulse hammer applies vibration to a structure by human power, when vibration is applied to a large structure such as a bridge with an impulse hammer, the vibrating force is significantly attenuated, and the resonance frequency may not be measured with desired accuracy. On the other hand, a general vibrator used in a modal testing can apply vibration with a magnitude sufficient to measure a resonance frequency of a large structure with desired accuracy.

For example, Non Patent Literature 2 describes a vibrator that is installed on a side of an automobile by being attached to a fixing device and vibrates a flat side surface as compared with a pipe or the like in the automobile. The vibrator described in Non Patent Literature 2 is configured to apply vibration to the automobile at a desired position on the side surface of the automobile by the vibrator itself rotating even when the stinger to be brought into contact with the side surface of the automobile slightly deviates. In addition, Non Patent Literature 3 describes a multi-axis simulation table capable of reproducing motions with six degrees of freedom in which a test body is attached to the installation base and the test body is vibrated.

### CITATION LIST

### Non Patent Literature

Non Patent Literature 1: Gakuho Watanabe, and three others, “Health Monitoring and Identification of Dynamic Characteristics of a Skewed Bridge based on the Vibration Test Using a Moving Vehicle”, The Japan Society of Civil Engineering, Journal of Structural Engineering, Vol. 60A, March 2014
Non Patent Literature 2: “MD-0348-revA (Modal Analysis Testing with Large Channel Systems Diagram-NVH)-1021”, [online], [Retrieved on Apr. 1, 2022], the Internet <URL: https://www.pcb.com/contentstore/MktgContent/LinkedDoc uments/AutomotiveSensors/ModalAnalysisDiagram-NVH2.pdf>
Non Patent Literature 3: Ryuji Uehara and five others, “Development of Precise Simulation System for Durability Testing of Vehicle Components”, Mitsubishi Heavy Industries, Ltd. Technical Review, VOL. 45, NO. 3, 2008

### SUMMARY OF INVENTION

### Technical Problem

However, since the vibrators described in Non Patent Literature 2 and Non Patent Literature 3 are installed visually, an object such as a structure may not be accurately vibrated in the normal direction of a surface of the object. In particular, since the stinger included in the vibrator has a thin rod-like structure with high flexibility, it is difficult to visually recognize that the vibrating direction in which the stinger extends has deviated from the normal direction of the surface of the object. As a result, it may be difficult to ascertain the characteristics of the object with high accuracy, and the stinger of the vibrator may be damaged.

The present invention has been made in view of such circumstances and aims to provide an alignment device and an alignment method capable of accurately performing alignment such that a vibrator applies vibration to an object in the normal direction of a surface of the object.

### Solution to Problem

In order to solve the above problem, an alignment device according to the present disclosure is an alignment device that aligns a vibrator body with an object, the vibrator body including a vibration generator that generates vibration, and a stinger having one end portion held by the vibration generator and extending in a vibrating direction that is a direction in which the vibration is generated, and the alignment device includes a laser emitter that emits laser light and is provided such that the laser light reaches a position on a straight line extending in the vibrating direction from a tip that is the end portion on the side opposite to the one end portion of the stinger, which is a position on the vibrating direction side from the tip, a laser receiver provided to receive the laser light emitted by the laser emitter and reflected by the object when the vibrator body is installed such that the vibrating direction is a normal direction of a surface of the object at a vibrating position, and a controller that determines whether an amount of the laser light received by the laser receiver is a predetermined value or greater.

In addition, in order to solve the above problem, an alignment method for a vibrator according to the present disclosure is an alignment method for an alignment device that aligns a vibrator body with an object, the vibrator body including a vibration generator that generates vibration, and a stinger having one end portion held by the vibration generator and extending in a vibrating direction that is a direction in which the vibration is generated, the alignment device including a laser emitter configured to emit laser light and provided such that the laser light reaches a position on a straight line extending in the vibrating direction from a tip that is the end portion on the side opposite to the one end portion of the stinger, which is a position on the vibrating direction side from the tip, and a laser receiver provided to receive the laser light emitted by the laser emitter and reflected by the object when the vibrator body is installed such that the vibrating direction is a normal direction of a surface of the object at a vibrating position, the alignment method including a step of emitting the laser light from the laser emitter, and a step of determining whether an amount of the laser light received by the laser receiver is a predetermined value or greater.

### Advantageous Effects of Invention

According to the present invention, the vibrator can be accurately aligned in the normal direction of a surface of an object to be able to vibrate the object.

### BRIEF DESCRIPTION OF DRAWINGS

FIG. 1 is a perspective view illustrating an example of a vibrator according to a first embodiment.

FIG. 2 is a perspective view illustrating a state in which the vibrator body illustrated in FIG. 1 vibrates an object located downwards.

FIG. 3 is a flowchart showing an alignment method for installing the vibrator body illustrated in FIG. 1.

FIG. 4 is a perspective view illustrating an example of a vibrator according to a second embodiment.

FIG. 5 is a perspective view illustrating an example of a vibrator according to a third embodiment.

FIG. 6 is a perspective view illustrating a modification of the vibrator illustrated in FIG. 1.

### DESCRIPTION OF EMBODIMENTS

### First Embodiment

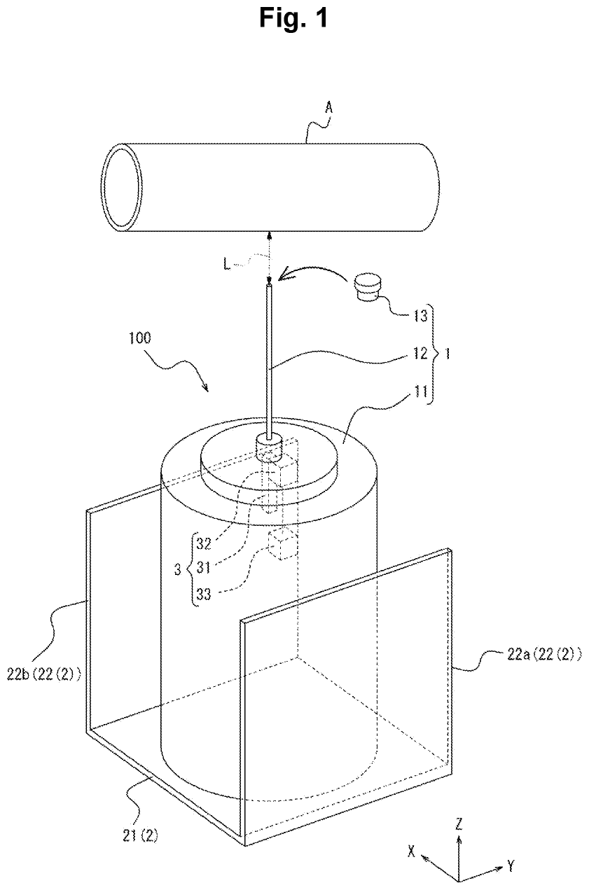

An overall configuration of a first embodiment will be described with reference to FIG. 1. FIG. 1 is a schematic view of a vibrator 100 according to the first embodiment.

As illustrated in FIG. 1, the vibrator 100 includes a vibrator body 1, a covering surface 2, and an alignment unit (alignment device) 3.

The vibrator body 1 applies vibration to an object A. The vibrator body 1 includes a vibration generator 11, a stinger 12, and an impedance head 13.

The vibration generator 11 generates vibration.

One end portion of the stinger 12 is held by the vibration generator 11 and extends in a vibrating direction in which vibration is generated (In the example of FIG. 1, the positive direction of the Z axis). The one end portion of the stinger 12 may pass through a stinger hole provided in the vibration generator 11 and be held by the vibration generator 11 with a screw or the like. Also, the stinger 12 may have a hollow therein extending in the extending direction of the stinger 12.

The impedance head 13 is a sensor that detects a physical quantity of vibration (magnitude, acceleration, and the like of a vibrating force). In addition, the impedance head 13 is also attached to an end portion (hereinafter, referred to as a “tip”) of the stinger 12 on the side opposite to the one end portion described above. The object A in contact with the impedance head 13 attached to the tip of the stinger 12 receives vibration applied by the stinger 12 causing the vibration generator 11 to generate vibration.

In addition, the impedance head 13 is also detachable. The impedance head 13 is detached from the stinger 12 during alignment and attached to the stinger 12 after completion of alignment and before vibration.

The covering surface 2 is a planar member that covers a part of the vibrator body 1. In the example illustrated in FIG. 1, the covering surface 2 has a first covering surface 21 and two second covering surfaces 22 (second covering surfaces 22a and 22b).

The first covering surface 21 is a planar member that covers a surface (bottom surface) of the vibrator body 1 on the side opposite to the vibrating direction. Specifically, the first covering surface 21 is a planar member that is disposed on the side of the vibrator body 1 on which the stinger 12 is not attached and that is orthogonal to the vibrating direction. The first covering surface 21 may have a hole penetrating the first covering surface 21.

The second covering surfaces 22 are planar members that cover surfaces (side surfaces) of the vibrator body 1 parallel to the vibrating direction. The second covering surfaces 22 may include two second covering surfaces 22a and 22b facing each other. In addition, the second covering surfaces 22 may have a hole penetrating the second covering surfaces 22.

The vibrator 100 is attached to a fixing device (not shown) such that the impedance head 13 attached to the stinger 12 is installed at a position and in a posture in which the impedance head 13 is in contact with the object A.

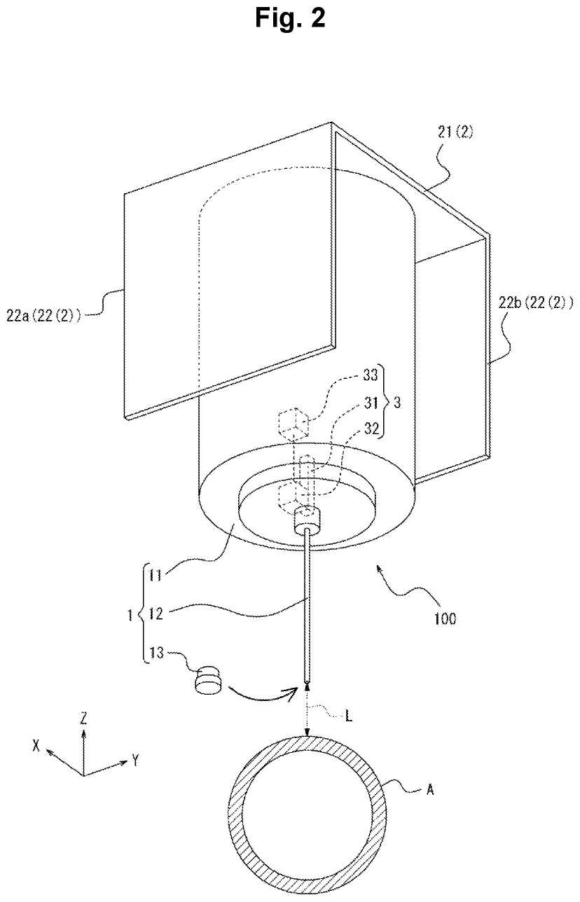

As an example, an end portion of a string-like elastic member may be attached to the covering surface 2 via a hole of the covering surface 2, and the elastic member may be suspended on the fixing device to attach the vibrator 100 to the fixing device. As an example, an end portion of the string-like elastic member may be attached to the first covering surface 21 via a hole of the first covering surface 21, and the elastic member may be suspended on the fixing device to attach the vibrator 100 to the fixing device such that the vibrating direction is the vertically downward direction (see FIG. 2). In addition, an end portion of the string-like elastic member may be attached to the second covering surface 22 via a hole of the second covering surface 22, and the elastic member may be suspended on the fixing device to attach the vibrator 100 to the fixing device such that the vibrating direction is the horizontal direction.

As another example, the vibrator 100 may be attached to the fixing device by fixing the covering surface 2 to the fixing device with a fixing member (e.g., a screw). The vibrator 100 may be attached to the fixing device by fixing the first covering surface 21 to the top surface of the fixing device with a fixing member such that the vibrating direction is the vertically upward direction. In addition, the vibrator 100 may be attached to the fixing device by fixing the first covering surface 21 to the bottom surface of the fixing device with a fixing member such that the vibrating direction is the vertically downward direction. In addition, the vibrator 100 may be attached to the fixing device by fixing the first covering surface 21 to a side surface of the fixing device with a fixing member such that the vibrating direction is the horizontal direction.

The alignment unit 3 aligns the vibrator body 1 with the object A. As illustrated in FIG. 1, the alignment unit 3 includes a laser emitter 31, a laser receiver 32, and a controller 33.

The laser emitter 31 is provided to emit laser light L such that the laser light L reaches a position on a straight line extending in the vibrating direction (In the example of FIG. 1, the positive direction of the Z axis) from the tip of the stinger 12, which is a position on the vibrating direction side from the tip. In the first embodiment, the laser emitter 31 is provided such that the laser light L emitted by the laser emitter 31 travels in the vibrating direction from the stinger 12.

In the example illustrated in FIG. 1, the laser emitter 31 is provided inside the vibrator body 1 such that the laser light L is emitted through the hollow of the stinger 12. As another example, the laser emitter 31 may be provided at the tip of the stinger 12. In this case, the stinger 12 may not have a hollow.

The laser receiver 32 is provided to receive the laser light L emitted by the laser emitter 31 and reflected by the object A when the vibrator body 1 is installed such that the vibrating direction is the normal direction of a surface of the object A at the vibrating position.

Note that, in FIG. 1, the size ratios of the laser emitter 31 and the laser receiver 32 to the vibrator body 1 are illustrated to be greater than the actual size ratios so as to be easily visually recognized on the paper. However, in practice, the laser emitter 31 and the laser receiver 32 have a size in which they can be arranged at a distance equal to or less than the diameter of the laser light L such that the laser light L reflected by the object A travels in the opposite direction along the optical path substantially the same as the optical path of the laser light L before the reflection, and at least a part of the reflected laser light L is received by the laser receiver 32.

In the example illustrated in FIG. 1, the laser receiver 32 is provided adjacent to the laser emitter 31. Specifically, the laser receiver 32 is provided to receive at least a part of the laser light L that is emitted from the laser emitter 31, incident in the normal direction of the object A, and reflected in the direction opposite to the incidence direction.

The controller 33 includes a controller. The controller may be configured by dedicated hardware such as an application specific integrated circuit (ASIC) or a field-programmable gate array (FPGA), may be configured by a processor, or may be configured to include both.

The controller 33 determines whether the amount of the laser light L received by the laser receiver 32 is a predetermined value or greater. The predetermined value is a value set based on the amount of the laser light L emitted by the laser emitter 31, and can be, for example, a predetermined proportion of the amount of the laser light L emitted by the laser emitter 31. The predetermined proportion may be determined based on the reflectance of the laser light L with respect to the object A, the positional relationship between the laser emitter 31 and the laser receiver 32, the degree of allowable error, and the like.

When it is determined that the amount of the laser light L received by the laser receiver 32 is the predetermined value or greater, the controller 33 executes control indicating that the vibrator body 1 has been installed normally. Here, “the vibrator body 1 has been installed normally” means that the vibrator body 1 is installed such that the vibrating direction is the normal direction of a surface of the object A at the vibrating position. For example, the controller 33 may transmit information indicating that the vibrator body 1 has been installed normally to another device via a communication network. Furthermore, the controller 33 may turn on a light emitting member (e.g., a light emitting diode (LED)) included in the vibrator 100. Furthermore, the controller 33 may cause a speaker included in the vibrator 100 to output a sound indicating that the vibrator body 1 has been installed normally.

When it is determined that the amount of the laser light L received by the laser receiver 32 is less than the predetermined value, the controller 33 executes control indicating that the vibrator body 1 has not been installed normally. For example, the controller 33 may transmit information indicating that the vibrator body 1 has not been installed normally to another device via a communication network. Furthermore, the controller 33 may turn off the light emitting member of the vibrator 100. Furthermore, the controller 33 may cause the speaker included in the vibrator 100 to output a sound indicating that the vibrator body 1 has not been installed normally.

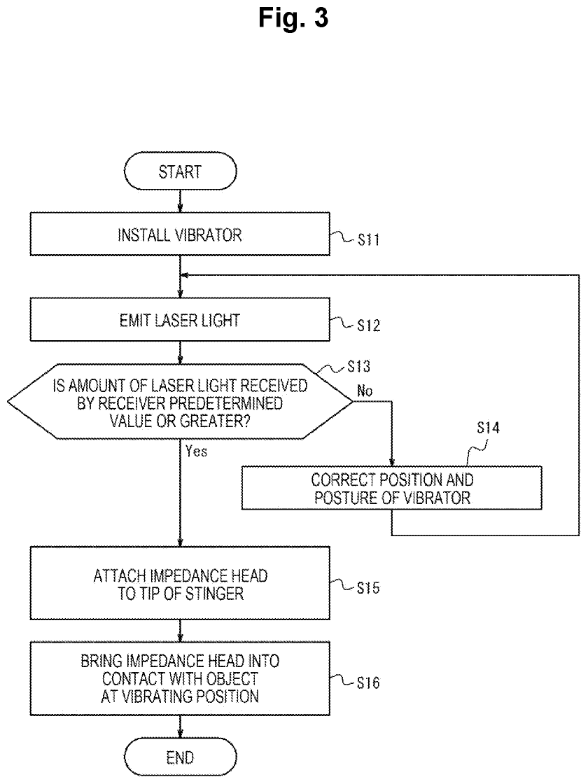

Here, an alignment process of the alignment unit 3 according to the first embodiment will be described with reference to FIG. 3. FIG. 3 is a flowchart showing an example of the alignment process of the alignment unit 3 according to the first embodiment. The alignment process of the alignment unit 3 described with reference to FIG. 3 corresponds to an example of an alignment method of the alignment unit 3 according to the first embodiment.

The vibrator body 1 is installed in step S11. At this time, the vibrator body 1 is installed such that the vibrating position of the object A is visually located in the direction in which the stinger 12 extends (that is, the vibrating direction).

In step S12, the laser emitter 31 emits laser light L.

In step S13, the controller 33 determines whether the amount of the laser light L received by the laser receiver 32 is the predetermined value or greater.

If it is determined in step S13 that the amount of the received laser light L is less than the predetermined value, the position and the posture of the vibrator body 1 are corrected in step S14, and the process returns to step S12.

If it is determined in step S13 that the amount of the laser light L received by the laser receiver 32 is equal to or greater than the predetermined value, the impedance head 13 is attached to the tip of the stinger 12 in step S15.

In step S16, the impedance head 13 is brought into contact with the object A at the vibrating position.

As described above, the alignment unit 3 according to the first embodiment aligns the vibrator body 1 with the object A. The vibrator body 1 includes the vibration generator 11 that generates vibration, and the stinger 12 having one end portion held by the vibration generator 11 and extending in a vibrating direction in which vibration is generated. The alignment unit 3 includes the laser emitter 31 that emits laser light L and is provided such that the laser light L reaches a position on a straight line extending in a vibrating direction from the tip of the stinger 12 on the side opposite to one end portion of the stinger 12, which is the position on the vibrating direction side from the tip, the laser receiver 32 that is provided to receive the laser light L emitted by the laser emitter 31 and reflected by the object A when the vibrator body 1 is installed such that the vibrating direction is the normal direction of the surface of the object A at a vibrating position, and the controller 33 that determines whether the amount of the laser light received by the laser receiver 32 is a predetermined value or greater.

With this configuration, the alignment unit 3 can accurately align the vibrator body 1 to apply vibration to the object A in the normal direction of the surface of the object A. Therefore, the vibration characteristics of the object A can be ascertained with high accuracy. In particular, in a case in which the surface of the object A is a curved surface like a pipe, if the vibrating direction deviates from the normal direction of the surface of the object A at a vibrating position, it is more difficult for the vibrator body 1 to appropriately apply vibration to the object A as compared with a case in which the surface is a flat surface. Therefore, in the case in which the surface of the object A is a curved surface, the alignment unit 3 in the first embodiment can contribute to ascertaining the vibration characteristics with significantly higher accuracy. Furthermore, since the vibrator body 1 is installed such that the vibrating direction is the normal direction of the surface of the object A at the vibrating position, it is possible to lower the possibility of the stinger 12 being bent during vibration and resulting in a failure.

Furthermore, in the alignment unit 3 according to the first embodiment, the controller 33 may execute control indicating that the vibrator body 1 has been installed normally if it is determined that the amount of the laser light L received by the laser receiver 32 is a predetermined value or greater, and execute control indicating that the vibrator body 1 has not been installed normally if it is determined that the amount of the laser light L received by the laser receiver 32 is less than the predetermined value. As a result, an operator who installs the vibrator body 1 can check whether the vibrator body 1 has been installed normally, and can appropriately correct the position and the posture of the vibrator body 1 so that the vibrator body 1 is installed normally.

Furthermore, the vibrator 100 according to the first embodiment may include the covering surface 2. By attaching the elastic member attached to the covering surface 2 to the fixing device, the vibrator body 1 can apply vibration to the object A provided at a high place on a bridge such as an attachment pipe, for example.

Note that, in the first embodiment, the vibrating position of the object A may be marked before step S11 is performed. In such an example, the laser light L is visible light, and it may be determined whether the laser light L emitted by the laser emitter 31 has reached the marked position before step S13. If it is determined that the laser light L has not reached the marked position, the process returns to step S12 after the position and the posture of the vibrator body 1 are corrected, and if it is determined that the laser light L has reached the marked position, the process may proceed to step S13. With this configuration, the alignment unit 3 performs alignment such that the vibrator body 1 accurately vibrates in the normal direction at the vibrating position of the object A and further vibration is applied to the object A at an accurate vibrating position.

### Second Embodiment

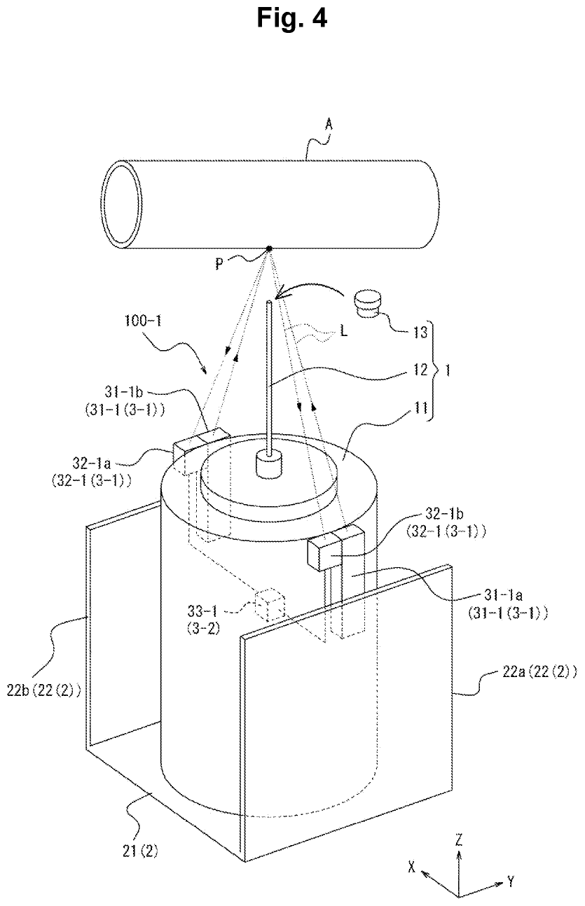

An overall configuration of a second embodiment will be described with reference to FIG. 4. FIG. 4 is a schematic view of a vibrator 100-1 according to the second embodiment. In the second embodiment, the same functional units as those in the first embodiment are denoted by the same reference numerals, and explanation thereof will be omitted.

As illustrated in FIG. 4, the vibrator 100-1 includes a vibrator body 1, a covering surface 2, and an alignment unit (alignment device) 3-1.

The alignment unit 3-1 includes two laser emitters 31-1 (a first laser emitter 31-1a and a second laser emitter 31-1b), two laser receivers 32-1 (a first laser receiver 32-1a and a second laser receiver 32-1b), and a controller 33-1.

The two laser emitters 31-1 are provided to emit laser light L such that the laser light L reaches a position on a straight line extending in the vibrating direction from the tip of the stinger 12, which is the same position in the vibrating direction side from the tip (the position P in the example illustrated in FIG. 4).

Specifically, the first laser emitter 31-1a is provided such that the laser light L emitted by the first laser emitter 31-1a reaches a position on a straight line extending in the vibrating direction from the tip of the stinger 12, which is a position on the vibrating direction side from the tip (the position P illustrated in FIG. 4). In the example illustrated in FIG. 4, the first laser emitter 31-1a is provided outside the vibrator body 1. However, the present invention is not limited thereto, and the first laser emitter 31-1a may be provided inside the vibrator body 1 such that the laser light L passes through a passage hole of the vibrator body 1 and exits to the outside of the vibrator body 1.

In addition, the second laser emitter 31-1b is provided such that the laser light L emitted by the second laser emitter 31-1b reaches a position (the position P illustrated in FIG. 4) on a straight line extending in the vibrating direction from the tip of the stinger 12 which the laser light L emitted by the first laser emitter 31-1a reaches. In the example illustrated in FIG. 4, the second laser emitter 31-1b is provided outside the vibrator body 1. However, the present invention is not limited thereto, and the second laser emitter 31-1b may be provided inside the vibrator body 1 such that the laser light L passes through the passage hole of the vibrator body 1 and exits to the outside of the vibrator body 1.

The two laser receivers 32-1 are provided to receive the laser light emitted by each of the two laser emitters 31-1 and reflected at the vibrating position when the vibrator body 1 is installed such that the vibrating direction is the normal direction of the object A at the vibrating position.

Specifically, the first laser receiver 32-1a is provided to receive the laser light L emitted by the first laser emitter 31-1a and reflected on the object A when the vibrator body 1 is installed such that the vibrating direction is the normal direction of a surface of the object A at the vibrating position. Although the first laser receiver 32-1a is provided on the side opposite to the first laser emitter 31-1a with respect to the stinger 12 in the plane in which the vibrating direction is the normal direction in the example illustrated in FIG. 4, the present invention is not limited thereto.

Specifically, the second laser receiver 32-1b is provided to receive the laser light L emitted by the second laser emitter 31-1b and reflected on the object A when the vibrator body 1 is installed such that the vibrating direction is the normal direction of a surface of the object A at the vibrating position. Although the second laser receiver 32-1b is provided on the side opposite to the second laser emitter 31-1b with respect to the stinger 12 in the plane in which the vibrating direction is the normal direction in the example illustrated in FIG. 4, the present invention is not limited thereto.

The controller 33-1 includes a controller. The controller 33-1 determines whether the amount of the laser light L received by each of the two laser receivers 32-1 is a predetermined value or greater.

If it is determined that the amounts of the laser light L received by the first laser receiver 32-1a and the second laser receiver 32-1b are the predetermined value or greater, the controller 33-1 executes control for indicating that the vibrator body 1 has been installed normally. The control executed by the controller 33-1 to indicate that the vibrator body 1 has been installed normally is, for example, similar to the control by the controller 33 in the first embodiment.

If it is determined that the amounts of the laser light L received by the two laser receivers 32-1 are less than the predetermined value, the controller 33-1 executes control indicating that the vibrator body 1 has not been installed normally. If it is determined that the amounts of the laser light L received by the first laser receiver 32-1a and the second laser receiver 32-1b are less than the predetermined value, the controller 33-1 executes control for indicating that the vibrator body 1 has not been installed normally. The control executed by the controller 33-1 to indicate that the vibrator body 1 has not been installed normally is, for example, similar to the control by the controller 33 in the first embodiment.

An alignment process of the alignment unit 3-1 according to the second embodiment is the same as the alignment process of the alignment unit 3 according to the first embodiment except for step S13.

In the second embodiment, the controller 33-1 determines whether the amounts of the laser light L received by the two laser receivers 32-1 are the predetermined value or greater in step S13. In the second embodiment, the two laser receivers 32-1 can receive laser light when the laser light L emitted by the two laser emitters 31-1 is positioned on a surface of the object A at the position P described above, and the vibrating direction is the normal direction of the surface of the stinger 12. If it is determined in step S13 that any of the amounts of the laser light L received by the two laser receivers 32-1 is less than the predetermined value, the process proceeds to step S14.

If it is determined in step S13 that all of the amounts of the laser light L received by the two laser receivers 32-1 are the predetermined value or greater, the process proceeds to step S15.

As described above, the alignment unit 3-1 according to the second embodiment includes the two laser emitters 31-1 and the two laser receivers 32-1, the two laser emitters 31-1 are provided such that laser light L emitted by each of the laser emitters reaches a position on a straight line extending from the tip of the stinger 12 in the vibrating direction, which is the same position on the vibrating direction side from the tip, and the two laser receivers 32-1 are provided to receive the laser light L emitted by each of the two laser emitters 31-1 and reflected at a vibrating position when the vibrator body 1 is installed such that the vibrating direction is the normal direction at the vibrating position of the object A. With this configuration, the alignment unit 3-1 can more accurately align the vibrator body 1 to apply vibration to the object A in the normal direction of the surface of the object A. Therefore, the vibration characteristics of the object A can be ascertained with higher accuracy.

Also, in the example illustrated in FIG. 4, the impedance head 13 may or may not be detachable. In the second embodiment, the laser light L does not pass through the hollow of the stinger 12, and neither of the two laser emitters 31-1 is attached to the tip of the stinger 12. Therefore, in a state in which the impedance head 13 is attached to the tip of the stinger 12, the laser light L emitted from the laser emitter 31-1 can reach the object A without being hindered by the impedance head 13. Thus, the vibrator body 1 can be aligned having the impedance head 13 attached to the tip of the stinger 12. As a result, it is possible to prevent the position or the posture of the vibrator body 1 from deviating in the attachment work of the impedance head 13 after the alignment. Accordingly, the alignment unit 3-1 can more accurately align the vibrator body 1 to apply vibration to the object A in the normal direction of the surface of the object A. Therefore, the vibration characteristics of the object A can be ascertained with higher accuracy.

### Third Embodiment

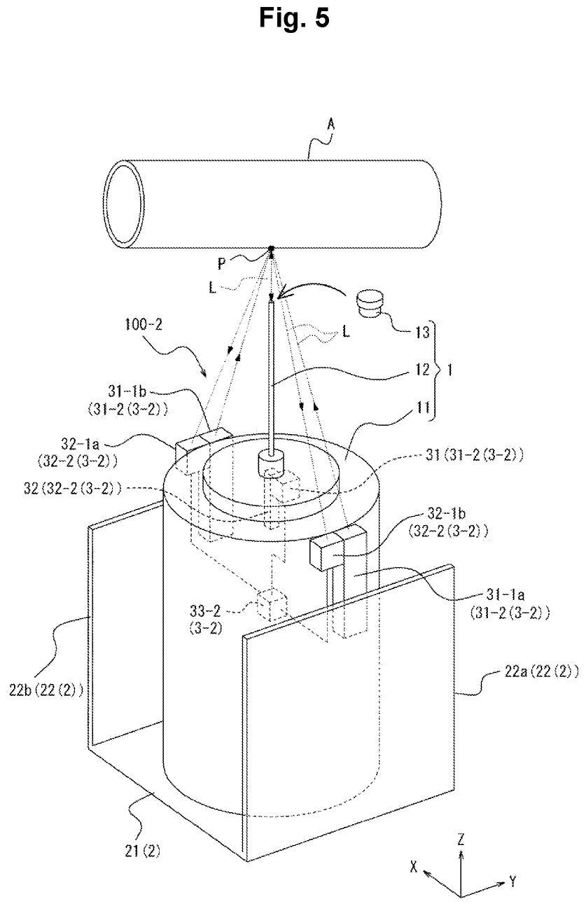

An overall configuration of a third embodiment will be described with reference to FIG. 5. FIG. 5 is a schematic view of a vibrator 100-2 according to the third embodiment. In the third embodiment, the same functional units as those in the first and second embodiments are denoted by the same reference numerals, and explanation thereof will be omitted.

As illustrated in FIG. 5, the vibrator 100-2 includes a vibrator body 1, a covering surface 2, and an alignment unit (alignment device) 3-2.

The alignment unit 3-2 includes three laser emitters 31-2, three laser receivers 32-2, and a controller 33-2. The three laser emitters 31-2 include the laser emitter 31 of the first embodiment, and the first laser emitter 31-1a and the second laser emitter 31-1b of the second embodiment. The three laser receivers 32-2 include the laser receiver 32 of the first embodiment, and the first laser receiver 32-1a and the second laser receiver 32-1b of the second embodiment.

The controller 33-2 includes a controller. The controller 33-2 determines whether the amount of laser light L received by each of the three laser receivers 32-2 is a predetermined value or greater. If it is determined that all of the amounts of laser light L received by the three laser receivers 32-2 are the predetermined value or greater, the controller 33-2 executes control indicating that the vibrator body 1 has been installed normally. The control executed by the controller 33-2 to indicate that the vibrator body 1 has been installed normally is, for example, similar to the control by the controller 33 in the first embodiment.

If it is determined that all of the amounts of laser light L received by the three laser receivers 32-2 are less than the predetermined value, the controller 33-2 executes control indicating that the vibrator body 1 has not been installed normally. Specifically, the control executed by the controller 33-2 to indicate that the vibrator body 1 has not been installed normally is, for example, similar to the control by the controller 33 in the first embodiment. An alignment process of the alignment unit 3-2 according to the third embodiment is the same as the alignment process of the alignment unit 3 according to the first embodiment except for step S13.

In the third embodiment, the controller 33-2 determines whether the amounts of the laser light L received by the three laser receivers 32-2 are the predetermined value or greater in step S13.

If it is determined in step S13 that any of the amounts of the laser light L received by the three laser receivers 32-2 is less than the predetermined value, the process proceeds to step S14.

If it is determined in step S13 that all of the amounts of the laser light L received by the three laser receivers 32-2 are the predetermined value or greater, the process proceeds to step S15.

As described above, the alignment unit 3-2 according to the third embodiment further includes the first laser emitter 31-1a, the second laser emitter 31-1b, the first laser receiver 32-1a, and the second laser receiver 32-1b of the second embodiment in addition to the alignment unit 3 of the first embodiment. With this configuration, the alignment unit 3-2 can more accurately align the vibrator body 1 to apply vibration to the object A in the normal direction of the surface of the object A. Therefore, the vibration characteristics of the object A can be ascertained with higher accuracy.

### First Modification

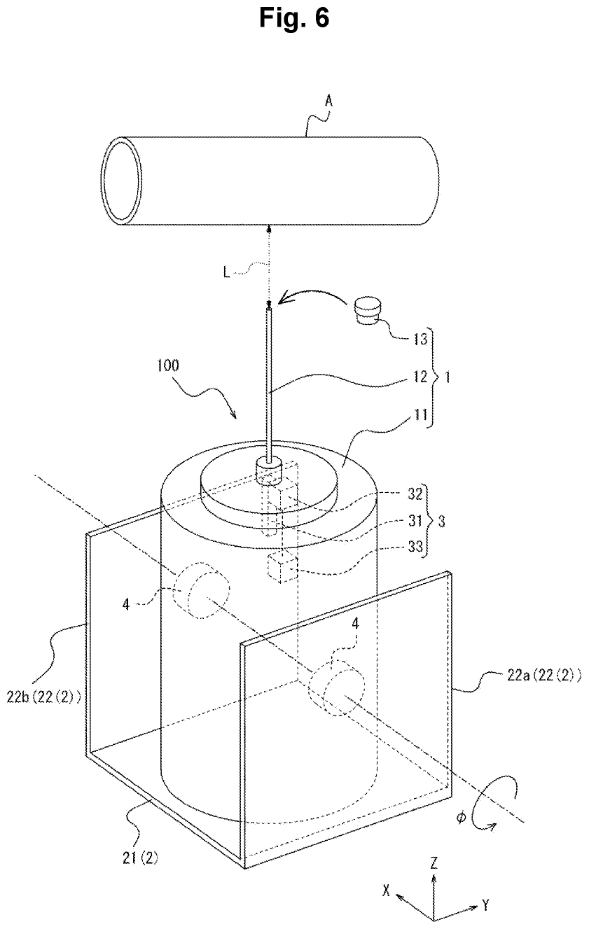

Note that, in the first embodiment described above, the vibrator 100 may further include a rotation shaft member 4 as illustrated in FIG. 6.

The rotation shaft member 4 is a member configured such that the vibrator body 1 is rotatable about an axis (ϕ axis) extending in the normal direction of the two mutually parallel second covering surfaces 22a and 22b. The rotation shaft member 4 may be a member that is attached to the vibrator body 1, slides on the second covering surfaces 22a and 22b, and rotates around the ϕ axis together with the vibrator body 1. The rotation shaft member 4 may be a member attached to the side surfaces on the second covering surfaces 22a and 22b side, and provided to cause the vibrator body 1 to slide around the rotation shaft member 4 and rotate around the ϕ axis.

Note that, in the configuration in which the vibrator 100 includes the rotation shaft member 4, the first covering surface 21 is a planar member that covers the surface (bottom surface) of the vibrator body 1 on the side opposite to the vibrating direction in a predetermined state (the state before the vibrator body 1 rotates). When the vibrator body 1 is rotated by 90 degrees around the ϕ axis from the predetermined state, the first covering surface 21 covers a surface (side surface) of the vibrator body 1 parallel to the vibrating direction, the surface becoming not covered by the second covering surfaces 22a and 22b.

In addition, in the configuration in which the vibrator 100 includes the rotation shaft member 4, the first covering surface 21 may have a hole, and the second covering surfaces 22a and 22b may have no holes. In addition, in the configuration in which the vibrator 100 includes the rotation shaft member 4, the first covering surface 21 may have no holes, and the second covering surfaces 22a and 22b may have holes.

Similarly, in the second embodiment described above, the vibrator 100-1 may further include the rotation shaft member 4, and in the third embodiment, the vibrator 100-2 may further include the rotation shaft member 4.

### Second Modification

Furthermore, in the first embodiment described above, the alignment unit 3 may include a laser light refraction member that includes a refraction lens, a half mirror, or the like and changes the traveling direction of the laser light L. For example, in a configuration in which the laser light refraction member is provided on the optical path from the laser emitter 31 to the object A, the laser receiver 32 is provided to receive reflected light created when the laser light L emitted by the laser emitter 31 and refracted by the laser light refraction member is reflected at the vibrating position in a case that the vibrator body 1 is installed such that the vibrating direction is the normal direction at the vibrating position of the object A. In addition, for example, in a configuration in which the laser light refraction member is provided on the optical path from the object A to the laser receiver 32, the laser receiver 32 is provided to receive reflected light created when the laser light L emitted by the laser emitter 31 is reflected at the vibrating position and refracted by the laser light refraction member in a case that the vibrator body 1 is installed such that the vibrating direction is the normal direction at the vibrating position of the object A. As a result, the degree of freedom in design for providing the laser emitter 31 and the laser receiver 32 in the vibrator body 1 increases.

Similarly, in the second embodiment described above, the alignment unit 3-1 may further include the laser light refraction member, and in the third embodiment, the alignment unit 3-2 may further include the laser light refraction member. As a result, the degree of freedom in design for providing the laser emitter 31-1 and the laser receiver 32-1, and the laser emitter 31-2 and the laser receiver 32-2 in the vibrator body 1 increases.

Although the above embodiments have been described as typical examples, it is obvious to those skilled in the art that many modifications and substitutions can be made within the spirit and scope of the present disclosure. Thus, it should not be understood that the present invention is limited by the above-described embodiment, and various modifications or changes can be made without departing from the scope of the claims.

### REFERENCE SIGNS LIST

1 Vibrator body
2 Covering surface
3, 3-1, 3-2 Alignment unit (alignment device)
4 Rotation shaft member
11 Vibration generator
12 Stinger
13 Impedance head
21 First covering surface
22, 22a, 22b Second covering surface
31, 31-1, 31-2 Laser emitter
31-1a First laser emitter
31-1b Second laser emitter
32, 32-1, 32-2 Laser receiver
32-1a First laser receiver
32-1b Second laser receiver
33, 33-1, 33-2 Controller
100, 100-1, 100-2 Vibrator

1. An alignment device configured to align a vibrator body with an object,
the vibrator body including:
a vibration generator configured to generate vibration, and
a stinger having one end portion held by the vibration generator and extending in a vibrating direction that is a direction in which the vibration is generated,
the alignment device comprising:
a laser emitter configured to emit laser light and provided such that the laser light reaches a position on a straight line extending in the vibrating direction from a tip that is the end portion on the side opposite to the one end portion of the stinger, which is a position on the vibrating direction side from the tip;
a laser receiver provided to receive the laser light emitted by the laser emitter and reflected by the object when the vibrator body is installed such that the vibrating direction is a normal direction of a surface of the object at a vibrating position; and
a controller configured to determine whether an amount of the laser light received by the laser receiver is a predetermined value or greater.

2. The alignment device according to claim 1, wherein the laser emitter is provided at the tip of the stinger, or is provided inside the vibrator body such that the laser light is emitted through a hollow of the stinger.

3. The alignment device according to claim 1, comprising:
two laser emitters and two laser receivers,
wherein the two laser emitters are provided such that laser light emitted by the laser emitters reach a position on a straight line extending in the vibrating direction from the tip of the stinger, which is the same position on the vibrating direction side from the tip, and
the two laser receivers are provided to receive laser light emitted by each of the two laser emitters and reflected at a vibrating position when the vibrator body is installed such that the vibrating direction is a normal direction at the vibrating position of the object.

4. The alignment device according to claim 1, wherein the controller executes control indicating that the vibrator body is installed normally if it is determined that an amount of the laser light received by the laser receiver is a predetermined value or greater, and executes control indicating that the vibrator body is not installed normally if it is determined that an amount of the laser light received by the laser receiver is less than the predetermined value.

5. An alignment method for an alignment device configured to align a vibrator body with an object,
the vibrator body including a vibration generator configured to generate vibration, and a stinger having one end portion held by the vibration generator and extending in a vibrating direction that is a direction in which the vibration is generated,
the alignment device including a laser emitter configured to emit laser light and provided such that the laser light reaches a position on a straight line extending in the vibrating direction from a tip that is the end portion on the side opposite to the one end portion of the stinger, which is a position on the vibrating direction side from the tip, and a laser receiver provided to receive the laser light emitted by the laser emitter and reflected by the object when the vibrator body is installed such that the vibrating direction is a normal direction of a surface of the object at a vibrating position,
the alignment method comprising:
emitting the laser light from the laser emitter; and
determining whether an amount of the laser light received by the laser receiver is a predetermined value or greater.

6. The alignment device according to claim 3, wherein a first laser emitting section is configured such that the laser beam emitted by the first laser emitting section is on a straight line extending from the tip of the stinger in the excitation direction; and
a second laser emitting section is configured such that the laser beam emitted by the second laser emitting section reaches the laser beam emitted by the first laser emitting section.

7. The alignment device according to claim 3, wherein two laser light receiving sections are connected to two laser emitting sections when an exciter main body is installed such that an excitation direction is a normal direction at the excitation position of the object.

8. The alignment device according to claim 7, wherein the exciter main body in a first laser receiver is installed such that the excitation direction is a normal direction at an excitation position on the surface of the object.

9. The alignment device according to claim 8, wherein the first laser receiving section is located on the opposite side of the first laser emitting section with respect to the stinger in a plane whose normal direction is the excitation direction.

10. The alignment device according to claim 3, wherein when the exciter main body in a second laser light receiving section is installed such that the excitation direction is the normal direction at the excitation position on the surface of the object.

11. The alignment device according to claim 10, wherein the second laser receiving section is provided on an opposite side of the second laser emitting section with respect to the stinger in a plane whose normal direction is the excitation direction.

12. The alignment device according to claim 3, wherein a controller determines whether the amount of laser light received by each of the two laser light receiving units is equal to or greater than a predetermined value.
